(19) United States
(12) Patent Application Publication
(10) Pub. No.: US 2024/0361232 A1
(43) Pub. Date: Oct. 31, 2024

(54) SOLID-STATE QUASI-COLLIMATION STACK AND OPTICAL MEASUREMENT SYSTEM CONTAINING THE SAME

(71) Applicant: Cerillo, INC, Charlottesville, VA (US)

(72) Inventors: Andrew Homyk, Charlottesville, VA (US); Kevin Seitter, Charlottesville, VA (US); Daniel Carrier, JR., Fort Collins, CO (US); Sydney DeCleene, Richmond, VA (US); Sruthi Gopinathan, Ashburn, VA (US)

(21) Appl. No.: 18/648,345

(22) Filed: Apr. 27, 2024

Related U.S. Application Data
(60) Provisional application No. 63/498,632, filed on Apr. 27, 2023.

(51) Int. Cl. G01N 21/01

(52) U.S. Cl. CPC G01N 21/01; G01N 2201/0633

(57) ABSTRACT

Herein are described a solid-state quasi-collimation stack and system containing the same. Also are described methods for narrow beamforming of electromagnetic radiation intended for the measurement of fluid samples. The solid-state quasi collimation stack typically comprises multiple layers of electromagnetic radiation blocking and absorbing components that selectively allow the passage of near-parallel electromagnetic beams.

### BACKGROUND OF THE INVENTION

Optical measurement systems for the evaluation of liquid sample parameters typically incorporate the use of an electromagnetic (EM) source and a transduction mechanism for evaluating the response of the EM radiation to the presence of a liquid sample. These systems often require the transformation of a diffuse, distributed, or wide-angle EM radiation source into a focused or collimated beam. Focusing or collimating the EM radiation allows for the targeted application of the radiation into a liquid sample for further reception and analysis.

Liquid samples for these types of applications are typically contained in vessels that preferentially allow the EM radiation to pass through the liquid to perform a measurement. Some such vessels comprise an array of multiple wells. One of the challenges to the measurement of these types of systems is that the individual wells holding liquid samples tend to be small-typically between 1 mm and 10 mm in diameter. If the EM beam passing through this liquid vessel is too large in cross-sectional diameter, it is likely that portions of the beam will be scattered, distorted by the shape of the liquid sample surface, or reflected by parts of the vessel, compromising the measurement results. Therefore, it is advantageous to focus or collimate the EM beam into a thin column before it passes through the liquid sample.

Conventional methods for achieving this focusing or collimation either use statically mounted lens arrays—wherein each lens inherently aligns with a sample, even when multiple samples are to be measured—or single-lens systems wherein the sample or samples can be robotically aligned with the single focused or collimated beam. Lenses of sufficient precision to form beams for the measurement of small-volume liquid samples are expensive to produce and can become cost-prohibitive. This is especially true for solid-state systems for the measurement of multiple samples, which would require sometimes hundreds of individual collimation or focusing sources in close proximity to each other.

Therefore, there is need for a solid-state method for collimating, narrowing, or otherwise focusing EM radiation in systems for the optical measurement of liquids without the use of lenses. This type of system would dramatically reduce the cost to the end user and not require the use of reliability-compromising moving components.

### SUMMARY OF THE INVENTION

In an aspect, there is described a solid-state quasi-collimation stack for narrow beamforming of electromagnetic radiation intended for the measurement of fluid samples, comprising multiple layers of electromagnetic radiation blocking and absorbing components that selectively allow the passage of near-parallel electromagnetic beams.

In another aspect, there is described a solid-state quasi-collimation stack, further comprising a detection system.

In another aspect, there is described a solid-state quasi-collimation stack for the measurement of liquid samples that is configured to measure samples contained in microplates.

These and other aspects, which will become apparent following the detailed description, have been achieved by the inventors' discovery of novel, solid-state quasi-collimation stacks.

### BRIEF DESCRIPTION OF THE DRAWINGS

FIG. 1 shows a cross-section of a quasi-collimation stack that illustrates electromagnetic reflection, absorption, and the resulting narrow beam formation.

FIG. 2 is an exploded view of a quasi-collimation stack.

FIG. 3 illustrates a quasi-collimation stack in alignment with a detection unit and a microplate.

FIG. 4 is a cross-section of a quasi-collimation stack in combination with a detection unit and a sample-containing vessel with a liquid sample.

FIG. 5 shows a cross-sectional view of components within a coupling assembly which surrounds a sample vessel to be placed within a sample-retaining component.

### DETAILED DESCRIPTION OF THE INVENTION

Exemplary aspects of the present invention are described herein. Although the following detailed description contains many specifics for purposes of illustration, a person of ordinary skill in the art will appreciate that variations and alterations to the following details are within the scope of the invention. Accordingly, the following aspects of the invention are set forth without any loss of generality to, and without imposing limitations upon, the claimed invention.

In aspect herein there is described an apparatus, comprising a combination of both electromagnetically shielding and absorbing layers, that functions to incrementally truncate the electromagnetic (EM) beam into a quasi-collimated form by way of selectively removing emissions not in tight alignment with the desired center axis.

In some aspects, this apparatus is configured so that it can measure the EM properties of liquid samples in scientific microplates. In these aspects, the apparatus makes use of one or more EM detectors in combination with the quasi-collimation apparatus to measure different parameters specific to the liquid sample's reaction to the applied EM radiation. These parameters can be related to, as an example: optical density, fluorescence, luminescence, or other EM reactions to higher frequency EM waveforms such as x-rays or gamma rays.

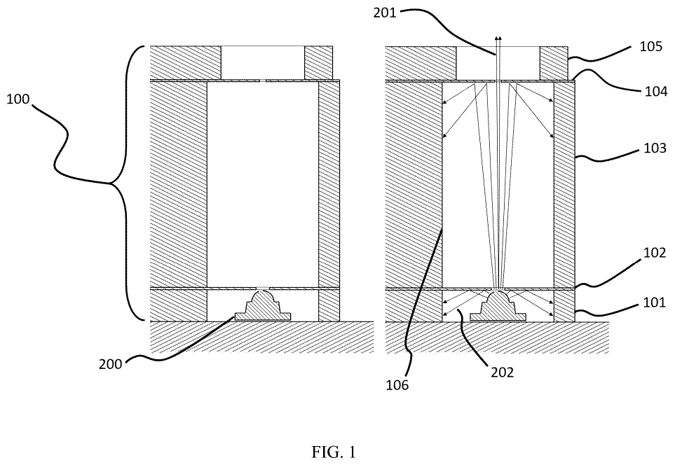

Names for components shown in FIGS. 1-5 are as follows:

| | |
|---|---|
| 100 | Electromagnetic (EM) radiation quasi-collimation stack |
| 200 | EM radiation source (emitter) |
| 300 | EM radiation detection system |
| 400 | Liquid sample containment vessel |
| 101 | EM Radiation Absorption Layer |
| 102 | First EM Radiation Reflection and Selection Layer |
| 103 | Spacing Layer (post-source EM absorption layer) |
| 104 | Second EM Radiation Reflection and Selection Layer |
| 105 | Mechanical Clamping Layer (top layer) |
| 106 | Absorption Layer Wall (spacing layer wall) |
| 107 | Exterior Registration Short Edge |
| 108 | Exterior Registration Long Edge |
| 109 | Mechanical Fixation Feature |
| 110 | Secondary Beam Selection Pinhole (2^{nd} selection layer pinhole) |
| 111 | Mechanical Alignment Feature |
| 112 | Housing Alignment Feature |
| 113 | EM Source Beam Selection Pinhole (1^{st} selection layer pinhole) |
| 114 | EM Absorption cylinder |
| 115 | EM Source Alignment Feature |
| 201 | Quasi-collimated EM beam form |
| 202 | Reflected EM radiation |
| 301 | EM Detector (optical receptor) |
| 302 | EM Detection Board |
| 303 | EM Detection Board Registration Features |
| 401 | Liquid Sample |
| 403 | Vessel Wall |
| 404 | Liquid Sample Surface |
| 500 | Coupling assembly |
| 501 | One component of coupling assembly |
| 502 | Coupling assembly alignment feature |
| 503 | Durable attachment feature |
| 504 | Durable component alignment feature |
| 505 | Sample-retaining component |
| 506 | Sample vessel |

Referring to FIG. 1, there is illustrated a cross-section of a solid-state quasi-collimation stack 100 in connection with one or more EM radiation sources (or emitters, e.g., a plurality of emitters) 200, comprising: a first electromagnetically absorbent layer 101 designed to radially collect incident emissions and reflections, a first electromagnetic reflection and selection layer 102 designed to selectively allow the passage of incident light waves within a specific angular range, a spacing layer 103 (a second electromagnetically absorbent layer) designed to radially collect incident emissions and reflections, which also acts as a spacing element between the first and second reflection and selection layers (102, 104), a second electromagnetic reflection and selection layer 104 designed to selectively allow for the passage of previously selected light waves within a further specified angular range, and a mechanical clamping layer 105 (e.g., top layer) designed to secure all components in the stack together and allow for component alignment. In some instances, the first electromagnetically absorbent layer (101) is referred to as an absorptive beam emitter separation layer. Examples of materials include plastic (101 and 103) and metal (e.g., stainless steel) (102, 104, and 105).

In another aspect, the first electromagnetic reflection and selection layer (102) is comprised of a digitally adjustable matrix of light-blocking elements that can be electronically and reversibly configured to form the pinholes.

In another aspect, the second electromagnetic reflection and selection layer (104) is comprised of a digitally adjustable matrix of light-blocking elements that can be electronically and reversibly configured to form the pinholes.

In another aspect, the solid-state quasi-collimation stack is substantially free from a focusing lens or lenses. Examples of substantially free include the absence of a focusing lens.

In another aspect, both the first and second electromagnetic reflection and selection layers (102, 104) are comprised of a digitally adjustable matrix of light-blocking elements that can be electronically and reversibly configured to form the pinholes.

In another aspect, the pinholes of the first and second first electromagnetic reflection and selection layers (102, 104) are less than or equal to two millimeters in diameter and the thickness of the selection layers (102, 104) is less than or equal to five hundred micrometers.

In other aspects, the solid-state quasi-collimation stack 100 further comprises: cylindrical walls 106 on the spacing layers 103 constructed from coarse, EM absorptive material such as a 3D printed surface with a deliberately optically arresting texture or an optically rough texture created using multi jet fusion or similar technology. In another aspect, walls 106 are created to have features to collect and absorb EM radiation such as, hollow cavities with slits cut into them for the collection of incident rays or angular surfaces designed to reflect and collect incident waveforms and/or absorb their emissive energy. Additionally, one skilled in the art could perceive other techniques such as texturizing the surface with sandblasting or laser engraving to create an absorptive surface specific to certain frequencies in the EM spectrum.

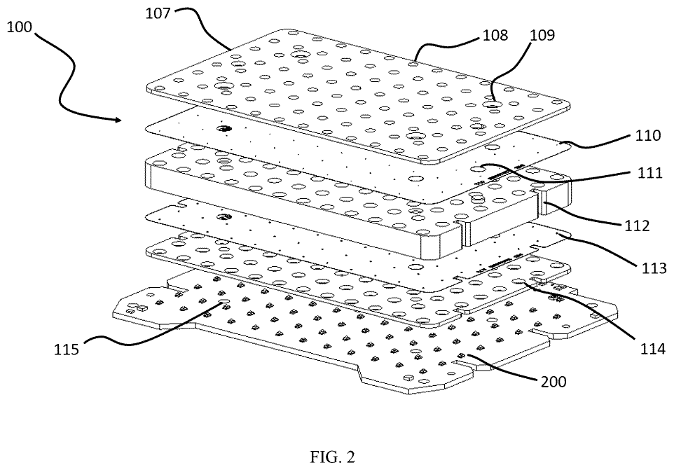

In FIG. 2, there is illustrated an exploded isometric view of an EM solid-state quasi-collimation stack 100 in mechanical alignment with a plurality of EM emission sources (emitters) 200 mounted to a printed circuit board. This illustration shows one example of a mechanical realization of the cross-sectional component stack shown in FIG. 1, arrayed to emit a plurality of quasi-collimated EM radiation beams. Said beams are first constrained by an electromagnetically absorptive chamber 114, and then pass through an electromagnetically transparent pinhole 113, followed by a second electromagnetically transparent pinhole 110. Further, FIG. 2 shows features for assembly and alignment of physical components, comprising: long side edges 108 and short side edges 107 designed to enable co-registration of components in stack 100, countersunk holes 109 that allow for the acceptance of self-aligning fasteners to both secure and align stack components, slotted holes 111 for the relative alignment of components in stack 100, side grooves 112 where components within the stack can be secured and aligned to features comprising a housing or case, holes 115 in circuit boards designed in a way to interface and align the boards to a mating housing or case.

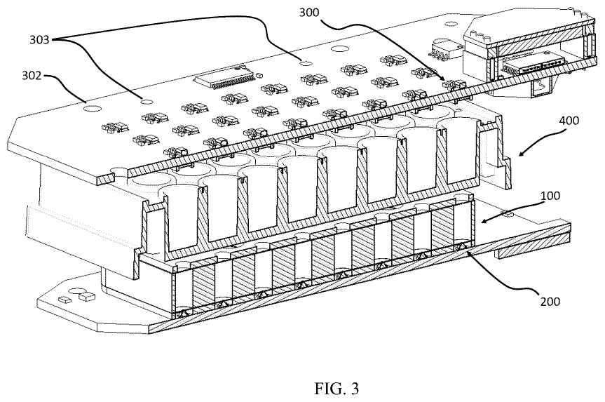

FIG. 3 illustrates an exploded, cross-sectional, isometric view of an EM solid-state quasi-collimation stack 100 in mechanical connection with a plurality of emitters 200 mounted to a base layer comprised of a printed circuit board, in alignment with a plurality of EM radiation detection systems 300 mounted to a second printed circuit board, all of which are further in alignment with an example sample vessel 400, in this case a commonly used 96-well scientific microplate. Other standard microplates may also be the basis of emitter-detector alignment, including but not limited to 6-well, 12-well, 24-well, or 384-well polystyrene microplates. Standard microplates are typically made of polystyrene. Microplates are known in the art but as used herein can include multiwell plates and/or microtiter plates. Other examples include polycarbonate and glass. The introduction of an EM radiation detection system 300 requires features for durable alignment of the detection system to the stack 100, comprising: mechanical mounting features such as screw holes 302 and registration features such as holes for pins 303. Alternative (or additional) durable alignment components include registration rails that contact an exterior edge with locating tabs, set screw positions for incremental adjustment of relative position, and/or datum surfaces meant to interface with locating pins, as examples. Also shown, but not number in FIG. 3 are electronic components (e.g., a microprocessor, wireless transceiver module, real time clock, etc.).

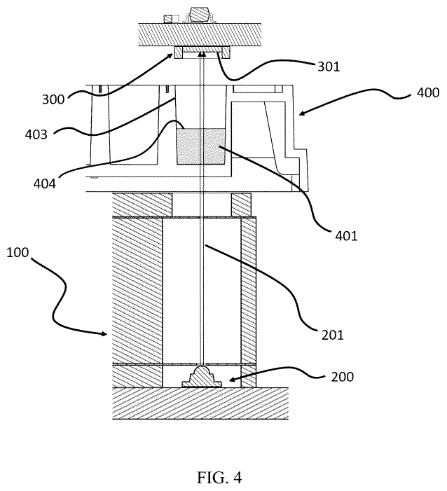

Referring to FIG. 4, there is illustrated an orthogonal cross-sectional view of a single instance of the arrayed EM emission system depicted in FIG. 3, comprising: a detector 301 durably mounted to a detection system 300, a quasi-collimated beam 201 generated by the combination of the EM solid-sate quasi-collimation stack 100 in mechanical connection with an EM emission source (emitter) 200. In this aspect, the apparatus is designed in such a way that the detector 301 is positioned to receive the incident EM radiation beam 201 after it has passed through liquid sample 401 to measure a parameter of the liquid sample. In this instance, it is desirable for the EM beam 201 to be narrowed to a degree where the diameter of the light beam does not exceed the size of the detector 301, or be diffracted by a sample-air interface 402 (not shown) in a way that would cause the extents of the EM beam to exceed the detector size or reflect or distort off the sides of the small-volume sample vessel 403.

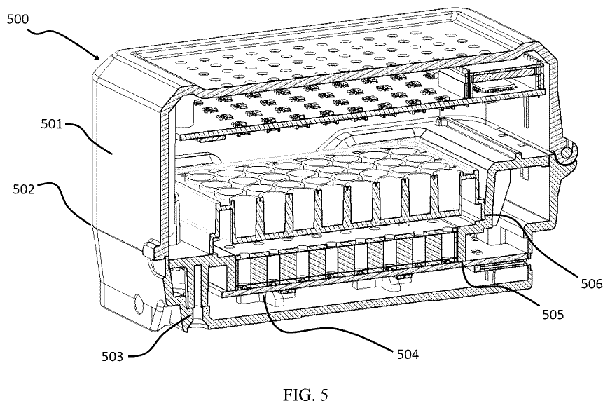

FIG. 5 shows a cross-sectional view of an example of an alignment of previously described components within a coupling assembly 500 that surrounds a sample vessel 506 to be placed within a sample-retaining component 505. In this example, these components are aligned via dedicated alignment features 504 and durably attached using permanent fasteners 503. Further in this example, an upper component 501 of the coupling assembly 500 may split from the rest of the assembly to enable the insertion and removal of the sample vessel 506 and then return back to its original configuration using dedicated alignment features 502.

Maintaining the shape of the EM beam 201 during liquid parameter measurement is critical for several reasons. Primarily, to make absolute measurements of liquid sample parameters, substantially all the EM energy emitted by the EM emission system 200 and not absorbed or scattered by the sample 401 should be collected by the EM detection system 300. “Substantially all” refers to at least 90, 95, 99, 99.5, and/or 99.9% of the EM energy emitted by the EM emission system 200 and not absorbed or scattered by the sample 401 is collected by the EM detection system 300. Secondarily, EM energy reflected off vessel walls 403 or refracted by the liquid-air interfaces 402 (not shown) could find its way to neighboring detectors in an arrayed system—this could alter the measurement results for parameters being measured in neighboring vessels. Therefore, the quasi-collimation of the EM radiation beam 201 represents an important and novel aspect for the development of solid-state liquid sample parameter measurement systems.

In another aspect, there is described a solid-state quasi-collimation stack, comprising:
a. a base layer;
b. one or more electromagnetic emitters (200) in fixed positions on the base layer;
c. a first electromagnetic radiation reflection and selection layer (102) covering the one or more emitters (200), comprising a material containing one or more electromagnetically transparent pinholes (113) in alignment with each emitter to form an emitter-pinhole pairing;
d. a spacing layer (103) covering the first selection layer, comprising an optically absorbent or black body material and containing, for each emitter-pinhole pairing, a channel in optical alignment therewith;
e. a second electromagnetic radiation reflection and selection layer (104) configured to cover the spacing layer (103), comprising a material containing, for each channel in the spacing layer, an electromagnetically transparent pinhole (110) in optical alignment therewith; and,
f. a top layer (105).

In another aspect, the quasi-collimation stack is for narrow beamforming of electromagnetic radiation intended for the measurement of fluid samples.

In another aspect, each of the one or more electromagnetic emitters in the stack is operable to transmit electromagnetic radiation at one or more wavelengths in the infrared, visible, or ultraviolet spectrum; and,

In another aspect, the emissions exiting the stack are confined to a narrow angular range via reflection and absorption of rays outside of that range.

In another aspect, the emissions exiting the stack are near-parallel to one another.

In another aspect, there is described a solid-state system for optical measurement of fluid samples, comprising:
a. the quasi-collimation stack described herein;
b. a sample-retaining component (505), configured to accept one or more fluid samples or a vessel comprising one or more fluid samples;
c. an optical detection system (300), comprising one or more optical receptors (301); and,
d. an emitter-detector coupling assembly (500) comprising a rigid frame or a series of interlocking or semi-permanently coupled parts;
wherein:
each receptor (301) is operable to detect the electromagnetic radiation from at least one of the emitters (200);
the sample-retaining component (505) places or can be configured to place the one or more fluid samples in optical alignment with at least one emitter's radiation, such that the radiation will pass through the one or more samples; and,
the coupling assembly (500) durably aligns, temporarily or permanently, the quasi-collimation stack, sample-retaining component, (505) and optical detection system, such that at least one of the emitter's emissions is in optical alignment with at least one sample and whose emissions pass through the sample to at least one the receptor.

In another aspect, the quasi-collimation stack further comprises:
g. an absorption layer (101) located between the base layer and the first selection layer (102) and containing an absorption column for each emitter present, each column being configured to circumscribe the corresponding emitter.

In another aspect, in the solid-state system there are the same number of emitters, first selection layer pinholes, spacing layers, second selection layer pinholes, and optical receptors.

In another aspect, the number of emitters, first selection layer pinholes, spacing layers, second selection layer pinholes, and optical receptors is 96. Additional examples include 6, 12, 24, and 284.

In another aspect, in the solid-state system the coupling assembly (500) comprises a single rigid case configured to block interfering electromagnetic emissions from outside of the frame or coupled parts, but which contains an opening for a sample or samples to be inserted.

In another aspect, the opening is covered by a flap.

In another aspect, in the solid-state system the coupling assembly comprises two rigid cases configured to couple and decouple with each other such that the one or more emitters and one or more optical receptors are in optical alignment when the cases are coupled.

In another aspect, in the solid-state system one case contains the quasi-collimation stack and one case contains the optical detection system and when coupled they define the sample-retaining component (505).

In another aspect, in the solid-state system the two cases are joined by a hinge to form a clamshell configuration.

In another aspect, there is described a method for the optical measurement of a fluid sample by passing collimated electromagnetic (EM) radiation through a well containing the fluid sample, the method, comprising:
a. beamforming EM radiation using a quasi-collimation stack;
b. directing the beamformed radiation to pass through the fluid sample contained in the well.

An example of optical measurement is measurement of optical density. Such measurements can be useful for performing immunoassays, measuring microbial growth, etc.

In another aspect, the method for optical measurement, further comprises:
c. detecting the radiation after passing through the sample via an optical receptor.

In another aspect, the beamforming, comprises the steps of:
i. passing electromagnetic radiation from an emitter through a first pinhole;
ii. passing the resulting radiation through a spacing layer; and,
iii. passing the resulting radiation through a second pinhole;
wherein the beamformed radiation is confined to a narrow angular range via reflection and absorption of rays outside of that range.

In another aspect, the beamforming, comprises the steps of:
i. passing electromagnetic radiation from an emitter through an absorptive beam emitter separation layer;
ii. passing the resulting radiation from an emitter through a first pinhole;
iii. passing the resulting radiation through a spacing layer; and,
iv. passing the resulting radiation through a second pinhole;
wherein the beamformed radiation is confined to a narrow angular range via reflection and absorption of rays outside of that range.

All references listed herein are individually incorporated herein in their entirety by reference. Numerous modifications and variations of the present invention are possible considering the above teachings. It is therefore to be understood that within the scope of the appended claims, the invention may be practiced otherwise than as specifically described herein.

1. A solid-state quasi-collimation stack, comprising:
a. a base layer;
b. one or more electromagnetic emitters (200) in fixed positions on the base layer;
c. a first electromagnetic radiation reflection and selection layer (102) covering the one or more emitters (200), comprising a material containing one or more electromagnetically transparent pinholes (113) in alignment with each emitter to form an emitter-pinhole pairing;
d. a spacing layer (103) covering the first selection layer, comprising an optically absorbent or black body material and containing, for each emitter-pinhole pairing, a channel in optical alignment therewith;
e. a second electromagnetic radiation reflection and selection layer (104) configured to cover the spacing layer (103), comprising a material containing, for each channel in the spacing layer, an electromagnetically transparent pinhole (110) in optical alignment therewith; and,
f. a top layer (105).

2. The quasi-collimation stack of claim 1, wherein each of the one or more electromagnetic emitters is operable to transmit electromagnetic radiation at one or more wavelengths in the infrared, visible, or ultraviolet spectrum.

3. The quasi-collimation stack of claim 1, wherein the emissions exiting the stack are confined to a narrow angular range via reflection and absorption of rays outside of that range.

4. The quasi-collimation stack of claim 1, wherein the emissions exiting the stack are near-parallel to one another.

5. The quasi-collimation stack of claim 1, wherein there are the same number of emitters, first selection layer pinholes, spacing layer, second selection layer pinholes, and optical receptors.

6. The quasi-collimation stack of claim 1, further comprising:
g. an absorption layer (101) located between the base layer and the first selection layer (102) and containing an absorption column for each emitter present, each column being configured to circumscribe the corresponding emitter.

7. The quasi-collimation stack of claim 1, wherein the pinholes of the first and second electromagnetic reflection and selection layers are less than or equal to two millimeters in diameter and the thickness of the selection layers is less than or equal to five hundred micrometers.

8. A solid-state system for optical measurement of fluid samples, comprising:
a. a quasi-collimation stack, comprising:
i. a base layer;
ii. one or more electromagnetic emitters (200) in fixed positions on the base layer;
iii. a first electromagnetic radiation reflection and selection layer (102) covering the one or more emitters (200), comprising a material containing one or more electromagnetically transparent pinholes (113) in alignment with each emitter to form an emitter-pinhole pairing;
iv. a spacing layer (103) covering the first selection layer, comprising an optically absorbent or black body material and containing, for each emitter-pinhole pairing, a channel in optical alignment therewith;
v. a second electromagnetic radiation reflection and selection layer (104) configured to cover the spacing layer (103), comprising a material containing, for each channel in the spacing layer, an electromagnetically transparent pinhole (110) in optical alignment therewith; and,
vi. a top layer (105);
b. a sample-retaining component (505), configured to accept one or more fluid samples or a vessel comprising one or more fluid samples;
c. an optical detection system (300), comprising one or more optical receptors (301); and,
d. an emitter-detector coupling assembly (500) comprising a rigid frame or a series of interlocking or semi-permanently coupled parts;
wherein:
each receptor (301) is operable to detect the electromagnetic radiation from at least one of the emitters (200);
the sample-retaining component (505) places or can be configured to place the one or more fluid samples in optical alignment with at least one emitter's radiation, such that the radiation will pass through the one or more samples; and,
the coupling assembly (500) durably aligns, temporarily or permanently, the quasi-collimation stack, sample-retaining component, (505) and optical detection system, such that at least one of the emitter's emissions is in optical alignment with at least one sample and whose emissions pass through the sample to at least one the receptor.

9. The solid-state system of claim 8, wherein the quasi-collimation stack, further comprises:
vii. an absorption layer (101) located between the base layer and the first selection layer (102) and containing an absorption column for each emitter present, each column being configured to circumscribe the corresponding emitter.

10. The solid-state system of claim 8, wherein there are the same number of emitters, first selection layer pinholes, spacing layer, second selection layer pinholes, and optical receptors.

11. The solid-state system of claim 8, wherein the pinholes of the first and second electromagnetic reflection and selection layers are less than or equal to two millimeters in diameter and the thickness of the selection layers is less than or equal to five hundred micrometers.

12. The solid-state system of claim 8, wherein the coupling assembly (500) comprises a single rigid case configured to block interfering electromagnetic emissions from outside of the frame or coupled parts, but which contains an opening for a sample or samples to be inserted.

13. The solid-state system of claim 8, wherein the coupling assembly comprises two rigid cases configured to couple and decouple with each other such that the one or more emitters and one or more optical receptors are in optical alignment when the cases are coupled.

14. The solid-state system of claim 13, wherein one case contains the quasi-collimation stack and one case contains the optical detection system and when coupled they define the sample-retaining component (505).

15. A method for the optical measurement of a fluid sample by passing collimated electromagnetic (EM) radiation through a well containing the fluid sample, the method, comprising:
a. beamforming EM radiation using a quasi-collimation stack;
b. directing the beamformed radiation to pass through the fluid sample contained in the well.

16. The method of claim 15, further comprising:
c. detecting the radiation after passing through the sample via an optical receptor.

17. The method of claim 15, wherein the beamforming, comprises the steps of:
i. passing electromagnetic radiation from an emitter through a first pinhole;
ii. passing the resulting radiation through a spacing layer; and,
iii. passing the resulting radiation through a second pinhole;
wherein the beamformed radiation is confined to a narrow angular range via reflection and absorption of rays outside of that range.

18. The method of claim 16, wherein the beamforming, comprises the steps of:
i. passing electromagnetic radiation from an emitter through a first pinhole;
ii. passing the resulting radiation through a spacing layer; and,
iii. passing the resulting radiation through a second pinhole;
wherein the beamformed radiation is confined to a narrow angular range via reflection and absorption of rays outside of that range.

19. The method of claim 15, wherein the beamforming, comprises the steps of:
i. passing electromagnetic radiation from an emitter through an absorptive beam emitter separation layer;
ii. passing the resulting radiation from an emitter through a first pinhole;
iii. passing the resulting radiation through a spacing layer; and,
iv. passing the resulting radiation through a second pinhole;
wherein the beamformed radiation is confined to a narrow angular range via reflection and absorption of rays outside of that range.

20. The method of claim 16, wherein the beamforming, comprises the steps of:
i. passing electromagnetic radiation from an emitter through an absorptive beam emitter separation layer;
ii. passing the resulting radiation from an emitter through a first pinhole;
iii. passing the resulting radiation through a spacing layer; and,
iv. passing the resulting radiation through a second pinhole;
wherein the beamformed radiation is confined to a narrow angular range via reflection and absorption of rays outside of that range.
